(19) United States
(12) Patent Application Publication
(10) Pub. No.: US 2007/0085935 A1
(43) Pub. Date: Apr. 19, 2007

(54) Trigger signal generator

(75) Inventor: Osamu Furukawa, Tokyo (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION

(21) Appl. No.: 11/581,409

(22) Filed: Oct. 17, 2006

(30) Foreign Application Priority Data
Oct. 18, 2005 (JP) P.2005-303341

(51) Int. Cl. H04N 5/50

(52) U.S. Cl. 348/735

(57) ABSTRACT

A trigger signal generator for outputting a trigger signal having a lower frequency than that of an input signal, the trigger signal generator including: a frequency divider circuit for dividing a frequency of the input signal; and a synchronizing circuit including a synchronizer for synchronizing the frequency-divided signal with the input signal.

This application claims foreign priority based on Japanese Patent Application No. 2005-303341, filed Oct. 18, 2005, the content of which is incorporated herein by reference in its entirety.

### BACKGROUND OF THE INVENTION

1. Field of the Invention

The present invention relates to a trigger signal generator for outputting a trigger signal whose frequency is lower than that of an input signal, and more particularly, to a trigger signal generator for generating a trigger signal that is in synchronization with the input signal and contains few jitters.

2. Description of the Related Art

The trigger signal generator is a circuit that generates a trigger signal (also called as a strobe signal) used to detect a status change of a measured signal. The trigger signal generator is used in a sampling circuit of a waveform measuring device such as an oscilloscope. The trigger signal generator is used to generate a trigger signal to cause a sampler (circuit for converting an analog signal into a digital signal by sampling a measured signal or the like of the analog signal) in a sampling circuit to start sampling (see U.S. Pat. No. 6,573,761, for example).

FIG. 7 is a view showing a configuration of the trigger signal generator in the related art (see JP-A-64-79666, for example). In FIG. 7, an input signal (e.g., a signal of a predetermined period, that is synchronized with a measured signal) is input into an input terminal Pi. This input signal is input from the input terminal Pi into a variable gain amplifier 10. A gain control circuit 11 is connected to the output side of the variable gain amplifier 10 and controls an amplification factor of the variable gain amplifier 10. A frequency detector circuit 12 is connected to the output side of the variable gain amplifier 10.

A switch SW1 is a 1-input/2-output switch, wherein an input terminal is connected to the output side of the variable gain amplifier 10. The switch SW1 switches a connection based on the instruction issued from the frequency detector circuit 12. A shaping circuit 13 is connected to one output terminal of the switch SW1. A frequency divider circuit 14 is connected to the other output terminal of the switch SW1.

A switch SW2 is a 2-input/1-output switch, wherein one input terminal is connected to the output side of the shaping circuit 13, and the other input terminal is connected to the frequency divider circuit 14, and an output terminal is connected to an output terminal Po. The switch SW2 switches a connection based on the instruction issued from the frequency detector circuit 12. The output terminal Po is a terminal used to output the trigger signal.

An operation of such apparatus will be explained hereunder.

The variable gain amplifier 10 amplifies the input signal input into the input terminal Pi up to a predetermined amplitude, and then outputs the amplified signal to the gain control circuit 11, the frequency detector circuit 12, and the switch SW1. Then, the gain control circuit 11 measures amplitude of the signal from the amplifier 10, and controls an amplification factor of the amplifier 10 to get predetermined amplitude.

The frequency detector circuit 12 detects a frequency of the input signal from the amplifier 10. The frequency detector circuit 12 causes the switches SW1, SW2 to connect to the shaping circuit 13 side when the frequency of the input signal is lower than a predetermined frequency. When the frequency of the input signal is higher than a predetermined frequency, the frequency detector circuit 12 causes the switches SW1, SW2 to connect to the frequency divider circuit 14 side.

In other words, when the frequency of the input signal input into the input terminal Pi is lower than the predetermined frequency, the shaping circuit 13 applies a waveform shaping to the signal from the switch SW1 without changing the frequency, and outputs a waveform-shaped signal to the output terminal Po via the switch SW2.

In contrast, when the frequency of the input signal input into the input terminal Pi is higher than the predetermined frequency, the frequency divider circuit 14 divides the frequency of the signal from the switch SW1 and outputs a frequency-divided signal to the output terminal Po via the switch SW2.

Then, the signal from either the shaping circuit 13 or the frequency divider circuit 14 is output from the output terminal Po as the trigger signal.

In this manner, since the frequency detector circuit 12 switches the connection of the switches SW1, SW2 in response to the frequency of the input signal, there is no need to select manually the shaping circuit 13 or the frequency divider circuit 14 in response to the frequency. Thus, automation of the measurement can be achieved. The reason why the shaping circuit 13 or the frequency divider circuit 14 is selected in response to the frequency of the input signal is that there is a limit to the operating frequency of the sampler that executes the sampling of the measured signal. Normally, an upper limit of the operating frequency of the sampler is about several tens of MHz.

Meanwhile, in recent data communication, a transmission rate of the data ranges between several tens of GHz/s and several hundreds of GHz/s. Therefore, when the trigger signal generator generates the trigger signal from the signal (e.g., the clock signal that is in synchronization with the measured signal) that is in synchronization with the data being fed at a high transmission rate, such trigger signal generator needs to divide the frequency of the input signal so that the frequency is in the operating frequency of the sampler.

The frequency divider circuit 14 includes frequency dividers such as a prescaler, a frequency divider and a frequency counter, and a circuit corresponding to the switches used to switch them. Since there is a limit to a range in which the individual frequency divider is able to divide the frequency, the frequency is divided into a predetermined frequency by using a plurality of frequency dividers provided at plural stages, as the frequency of the input signal is increased higher. The jitter is generated in the frequency dividers respectively. In this case, the jitters generated in the individual frequency dividers accumulate as the number of the frequency dividers is increased more and more.

For example, when the frequency of the input signal is 50 GHz (i.e., one period is 20 ps), it is general that the jitter of 100 to 200 fs r.m.s. (root mean square) is contained in the input signal itself. However, such jitter can be safely ignored in comparison with the period of the input signal.

However, the jitter generated in the frequency divider circuit 14 cannot be ignored as the number of the frequency dividers that are cascade-connected at a plurality of stages is increased. When the frequency 50 GHz of the input signal is divided into about 10 MHz, the jitter of about 1 ps r.m.s. is generated in the commercially available frequency divider circuit 14. Therefore, when the sampler executes the sampling of the measured signal by using the trigger signal of the trigger signal generator shown in FIG. 7, the jitter is contained in the trigger signal itself. As a result, it is difficult to execute the sampling of the measured signal with good accuracy.

### SUMMARY OF THE INVENTION

The present invention has been made in view of the above circumstances, and provides a trigger signal generator capable of generating a trigger signal that is in synchronization with an input signal and contains few jitters.

In some implementations, a trigger signal generator for outputting a trigger signal having a lower frequency than that of an input signal, the trigger signal generator comprising:

a frequency divider circuit for dividing a frequency of the input signal; and

a synchronizing circuit including a synchronizer for synchronizing the frequency-divided signal with the input signal.

Accordingly, the synchronizing circuit synchronizes the frequency-divided signal with the input signal having high frequency before being frequency-divided by the frequency divider as a reference. Therefore, the trigger signal, from which the jitter generated in the frequency divider circuit is removed, can be generated. As a result, the trigger signal that is in synchronization with the input signal and contains few jitters can be generated.

The trigger signal generator of the invention further comprising:

a frequency detector circuit for detecting a frequency of the frequency-divided signal and controlling a dividing ratio of the frequency divider circuit.

Accordingly, the frequency detector circuit performs frequency detection by the frequency-divided signal having low frequency. Therefore, the frequency detector circuit can be constructed with a circuit that can be implemented easier than the configuration that detects the high-frequency input signal, and also a cost can be suppressed low.

In the trigger signal generator of the invention, the synchronizer is a Delay flip-flop including:

a data input terminal into which the frequency-divided signal is input; and

a clock input terminal into which the input signal is input.

In the trigger signal generator of the invention, the synchronizing circuit includes:

a delaying section for delaying the frequency-divided signal and outputting the delayed signal to the synchronizer.

Accordingly, the delaying section delays the frequency-divided signal for a predetermined period and outputs the delayed signal to the synchronizer. Therefore, for example, generation of the meta-stable can be suppressed and the trigger signal of good waveform quality can be output.

In the trigger signal generator of the invention, the synchronizing circuit includes:

a waveform shaper for shaping a waveform of the frequency-divided signal and outputting the waveform-shaped signal to the synchronizer.

Accordingly, the waveform shaper speeds up a rising edge and a falling edge of the frequency-divided signal. Therefore, generation of the meta-stable can be suppressed and the trigger signal of good waveform quality can be output.

The trigger signal generator of the invention further comprising:

an amplitude adjusting section for adjusting an amplitude of the input signal and outputting the amplitude-adjusted signal, the amplitude adjusting section being provided at a front stage of the frequency divider circuit and the synchronizing circuit.

Accordingly, the amplitude adjusting section adjusts the amplitude of the input signal. Since the input signal whose amplitude is controlled is input into the frequency divider circuit and the synchronizing circuit, the frequency divider circuit and the synchronizing circuit can be operated optimally and stably. Therefore, the jitter generated in the frequency divider circuit and the synchronizing circuit can be suppressed further. As a result, the trigger signal that is in synchronization with the input signal and contains few jitters can be generated.

In the trigger signal generator of the invention, the trigger signal causes a sampler of a waveform measuring device to start sampling.

Accordingly, the waveform measuring device performs the sampling of the measured signal by the trigger signal having few jitters. Therefore, the measured signal can be measured with high accuracy.

### BRIEF DESCRIPTION OF THE DRAWINGS

FIG. 1 is a configurative view showing a first embodiment of the present invention.

FIG. 2A is a timing chart of the trigger signal generator shown in FIG. 1.

FIG. 2B is an enlarged view of the dotted area in FIG. 2A.

FIG. 3 is a configurative view showing a second embodiment of the present invention.

FIG. 4 is a timing chart of the trigger signal generator shown in FIG. 3.

FIG. 5 is a configurative view showing a third embodiment of the present invention.

FIG. 6 is a configurative view showing a fourth embodiment of the present invention.

FIG. 7 is a view showing a configuration of a trigger signal generator in the related art.

### DESCRIPTION OF THE PREFERRED EMBODIMENTS

Embodiments of the present invention will be explained with reference to the drawings hereinafter.

### First Embodiment

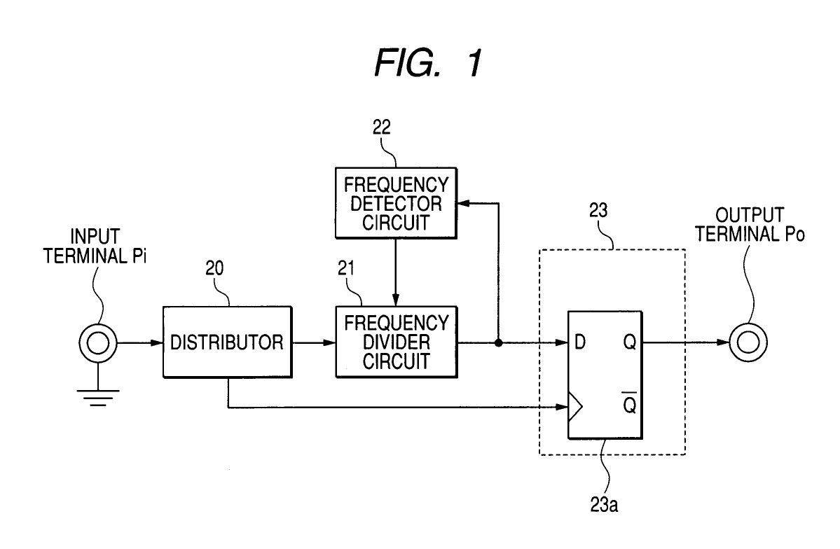

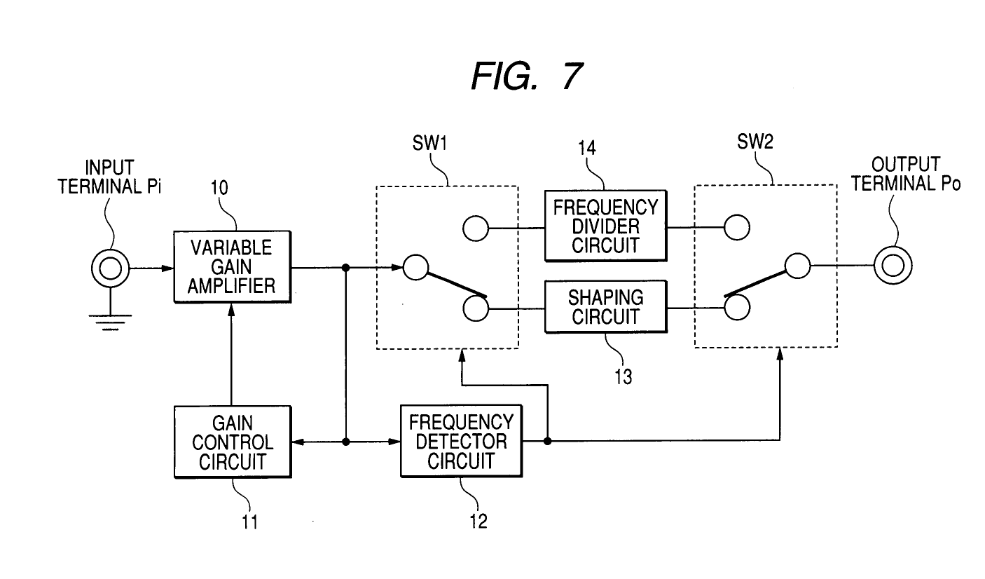

FIG. 1 is a configurative view showing a first embodiment of the present invention. Here, the same reference symbols are affixed to the same sections as those in FIG. 7 and their explanation will be omitted herein. In FIG. 1, a distributor 20 receives the input signal at its input terminal Pi, and branches the input signal into two parts and outputs them. A frequency divider circuit 21 receives one of the signals branched by the distributor 20, and divides the frequency of the input signal and outputs it. A frequency detector circuit 22 receives the signal whose frequency is divided by the frequency divider circuit 21, then detects the frequency of the input signal, and then controls a dividing ratio of the frequency divider circuit 21.

A synchronizing circuit 23 has a D-type flip-flop (abbreviated as DFF (Delay flip-flop) hereinafter) 23a. The synchronizing circuit 23 receives the signal whose frequency is divided from the frequency divider circuit 21 and also receives the other signal branched by the distributor 20. The synchronizing circuit outputs the signal from the frequency divider circuit 21 to an output terminal Po in synchronization with the input signal from the distributor 20.

The DFF 23a is a synchronizer. This DFF 23a receives the signal from the frequency divider circuit 21 at its data input terminal and receives the signal from the distributor 20 at its clock input terminal, and outputs the trigger signal from its data output terminal to the output terminal Po.

An operation of such generator will be explained hereunder.

The distributor 20 branches the signal input into its input terminal Pi into two identical signals, and outputs one signal to the frequency divider circuit 21 and outputs the other signal to the clock input terminal of the DFF 23a of the synchronizing circuit 23.

Then, the frequency divider circuit 21 divides the frequency of the input signal into a low frequency, and outputs the divided signal (referred to as the frequency-divided signal hereinafter) to the frequency detector circuit 22 and the data input terminal of the DFF 23a. Also, the frequency detector circuit 22 detects the frequency of the frequency-divided signal to check whether or not such frequency is a predetermined frequency. Then, the frequency detector circuit 22 outputs a control signal to the frequency divider circuit 21 to divide the frequency into the predetermined frequency.

The frequency divider circuit 21 is constructed by a single or plural frequency dividers (prescaler, frequency divider, frequency counter, or the like), and circuits corresponding to switches used to switch between respective frequency dividers. Under control of the control signal, the frequency divider circuit 21 selects the frequency divider or a combination of the frequency dividers which gives a desired dividing ratio, based on integer frequency division or fraction frequency division, or the like. Also, the frequency detector circuit 22 may be constructed by a hardware such as an analog arithmetic circuit or a digital logic circuit, or a software executed by CPU (Central Processing Unit), DSP (Digital Signal Processor), or the like. Since the frequency detection and control of the frequency divider circuit 21 can be executed automatically, automation of the measurement and power saving in the sampling oscilloscope, or the like can be achieved.

Meanwhile, the DFF 23a outputs the low-frequency frequency-divided signal from its data output terminal to the output terminal Po in synchronization with the high-frequency input signal being input from the distributor 20. The high-frequency input signal is mentioned in contrast to the frequency of the frequency-divided signal. Then, this frequency-divided signal is output to the sampler, for example, from the output terminal Po as the trigger signal.

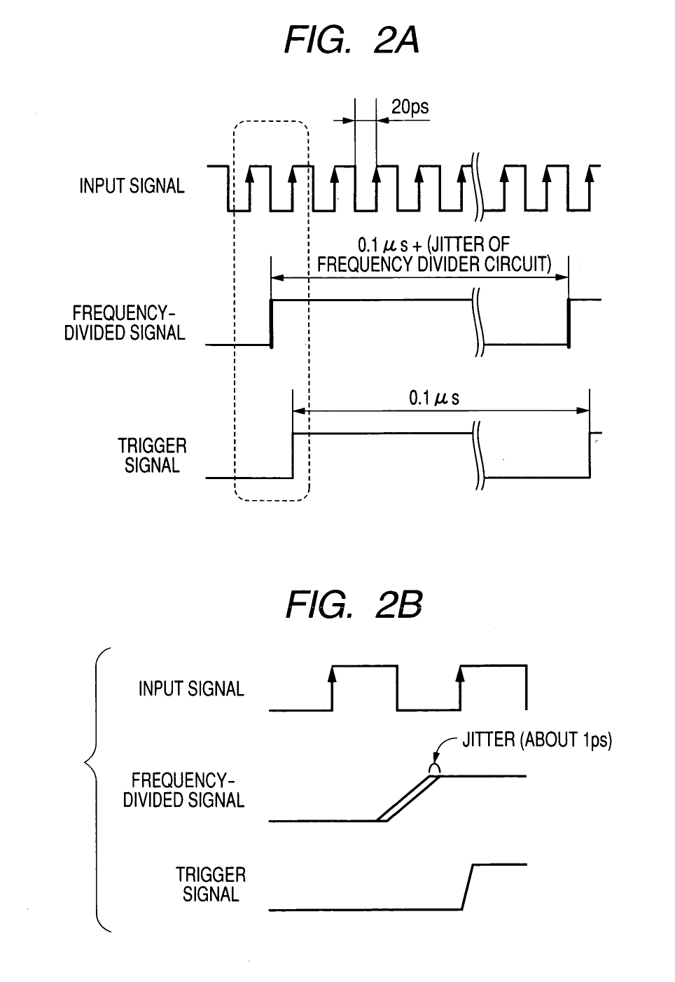

Next, an example in which the frequency of the input signal is set to 50 GHz and the frequency divided by the frequency divider circuit 21 is set to 10 MHz will be explained-hereunder. Also, FIGS. 2A and 2B are charts showing timings of the circuits shown in FIG. 1. FIG. 2A shows one period of the frequency-divided signal, and FIG. 2B is an enlarged view of a part (a rising portion of the frequency-divided signal) in FIG. 2A. Also, both FIGS. 2A and 2B show the input signal output from the distributor 20, the frequency-divided signal output from the frequency divider circuit 21, and the trigger signal output from the synchronizing circuit 23 in order from the top. A horizontal axis denotes a time and a vertical axis denotes a level. Also, the DFF 23a detects a rising edge of the signal that is input into its clock input terminal, and updates the data.

As shown in FIG. 2A, one period of the frequency-divided signal is given by 0.1 μs+(jitter generated in the frequency divider circuit) because of the jitter generated in the frequency divider circuit 21. In contrast, since the DFF 23a establishes the synchronization based on the input signal from the distributor 20, i.e., the signal that does not contain the jitter of the frequency divider circuit 21, the jitter generated in the frequency divider circuit 21 is removed from the trigger signal.

In this manner, the DFF 23a of the synchronizing circuit 23 establishes the synchronization of the frequency-divided signal of the frequency divider circuit 21 on the basis of the high-frequency input signal prior to the frequency division made by the frequency divider circuit 21. Therefore, the trigger signal can be generated wherein the jitter generated in the frequency divider circuit 21 is removed can be generated. As a result, the trigger signal that is in synchronization with the input signal and contains few jitters can be generated, and also the sampling of the measured signal can be executed with good accuracy in the waveform measuring device, or the like.

Now, the jitter is also generated from the DFF 23a itself. In this case, since normally the jitter generated in the DFF 23a is smaller than the frequency of the input signal serving as the clock signal of the DFF 23a by several digits (e.g., 50 GHz, or 20 ps in a period), such jitter can be safely ignored. Thus, the jitter contained in the trigger signal can be regarded to the same extent as the jitter contained in the input signal originally.

Also, the frequency detector circuit 22 executes the frequency detection based on the signal whose frequency is divided into the low frequency by the frequency divider circuit 21. Therefore, such frequency detector circuit can be constructed with a simple circuit more easily rather than the configuration that detects the high-frequency input signal as shown in FIG. 7, and also a cost can be kept low.

### Second Embodiment

FIG. 3 is a configurative view showing a second embodiment of the present invention. Here, the same reference symbols are affixed to the same sections as those in FIG. 1 and their explanation will be omitted herein, and also illustrations other than the synchronizing circuit 23 are omitted herein. In FIG. 3, a variable delaying section 23b is newly provided to the synchronizing circuit 23. The variable delaying section 23b is provided between the frequency divider circuit 21 and the data input terminal of the DFF 23a. The variable delaying section 23b causes the frequency-divided signal from the frequency divider circuit 21 to delay by a predetermined period and outputs the delayed signal to the data input terminal of the DFF 23a.

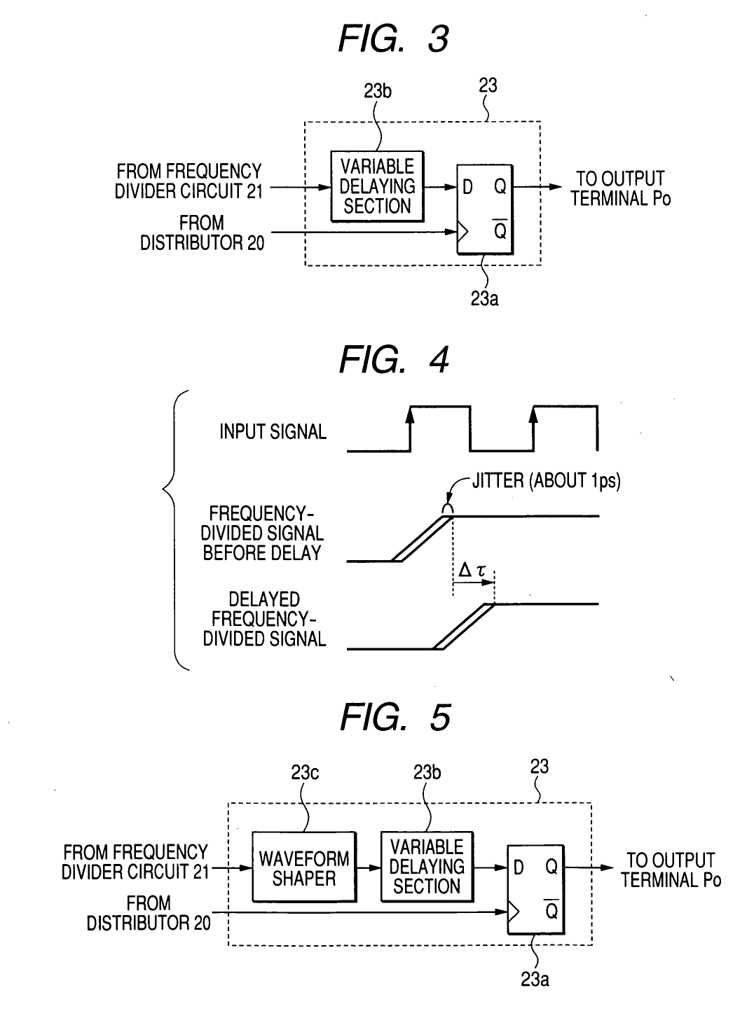

An operation of such generator will be explained hereunder. FIG. 4 is a timing chart showing the operation of the equipment shown in FIG. 3. Here, explanation of the same sections as those in FIG. 2B will be omitted herein. FIG. 4 shows in order from the top, the input signal, the “frequency-divided signal before the delay” output from the frequency divider circuit 21, and the “delayed frequency-divided signal” output from the variable delaying section 23b.

A delay is generated in the frequency divider circuit 21. Depending upon combinations of the selected frequency dividers, as shown in FIG. 4, the rising edge or the falling edge (not shown) of the frequency-divided signal overlaps with the rising edge of the signal supplied to the clock input terminal of the DFF 23a. Thus, in some cases the data output of the DFF 23a is brought into its unstable state, i.e., so-called meta-stable state.

Therefore, the variable delaying section 23b delays the frequency-divided signal from the frequency divider circuit 21 by a predetermined time Δτ (see FIG. 4), and then outputs the delayed signal to the DFF 23a. Since remaining operations are similar to those of the generator shown in FIG. 1, their explanation will be omitted herein.

In this case, the variable delaying section 23b may switch electrically a plurality of combinations of fixed delay devices, or may change an amount of delay by virtue of mechanical control, or the like.

In this manner, the variable delaying section 23b delays the frequency-divided signal from the frequency divider circuit 21 by a predetermined time Δτ, and then outputs the delayed signal to the DFF 23a. Therefore, generation of the meta-stable can be suppressed and thus the trigger signal of good waveform grade can be output.

### Third Embodiment

FIG. 5 is a configurative view showing a third embodiment of the present invention. Here, the same reference symbols are affixed to the same sections as those in FIG. 3 and thus their explanation will be omitted herein, and also illustrations other than the synchronizing circuit 23 are omitted herein. In FIG. 5, a waveform shaper 23c is newly provided to the synchronizing circuit 23. The waveform shaper 23c is provided between the frequency divider circuit 21 and the variable delaying section 23b. The waveform shaper 23c applies a waveform shaping to the frequency-divided signal fed from the frequency divider circuit 21, and outputs a resultant signal to the variable delaying section 23b.

An operation of such generator will be explained hereunder. A delay is generated in the frequency divider circuit 21. In this case, when the waveform is deteriorated further and thus the rising edge and the falling edge are rounded (i.e., a rise time from a low level to a high level and a fall time from a high level to a low level are prolonged), these edges more readily overlap with the rising edge of the signal fed to the clock input terminal of the DFF 23a. Thus, in some cases the data output of the DFF 23a is brought into the unstable state, i.e., the so-called meta-stable state.

Therefore, the waveform shaper 23c applies a waveform shaping to the frequency-divided signal from the frequency divider circuit 21 to speed up the rising edge and the falling edge (i.e., the rise time and the fall time are shortened), and outputs a resultant signal to the variable delaying section 23b. Since remaining operations are similar to those of the equipment shown in FIG. 3, their explanation will be omitted herein.

As the waveform shaper 23c, for example, a latch circuit, a Schmitt trigger circuit, or the like may be employed. Alternately, a series connection of a second variable delaying section and a second DFF may be employed. In this case, the frequency-divided signal from the second variable delaying section is input into the data input terminal of the second DFF, the input signal from the distributor 20 is input into the clock input terminal, and a signal from the data output terminal is output to the variable delaying section 23b. The stable synchronization may be attained by the cascade structure of the synchronizers.

In this manner, the waveform shaper 23c speeds up the rising edge and the falling edge of the frequency-divided signal from the frequency divider circuit 21. Therefore, generation of the meta-stable can be suppressed and also the trigger signal of good waveform grade can be output.

### Fourth Embodiment

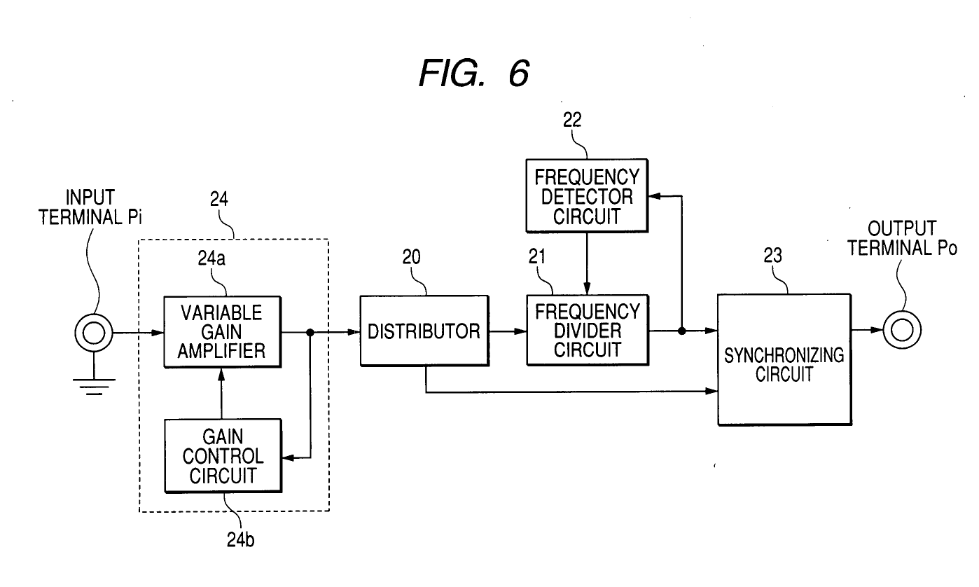

FIG. 6 is a configurative view showing a fourth embodiment of the present invention. Here, the same reference symbols are affixed to the same sections as those in FIG. 1, FIG. 3, FIG. 5, and thus their explanation will be omitted herein. In FIG. 6, an amplitude controlling section 24 is provided between the input terminal Pi and the distributor 20.

The amplitude controlling section 24 has a variable gain amplifier 24a and a gain control circuit 24b. The amplitude controlling section 24 amplifies or attenuates the amplitude of the input signal from the input terminal Pi to a predetermined amplitude, and the outputs a resultant signal to the distributor 20. The variable gain amplifier 24a receives the input signal from the input terminal Pi. The gain control circuit 24b is connected to the output side of the variable gain amplifier 24a, and controls an amplification factor of the variable gain amplifier 24a.

An operation of such generator will be explained hereunder.

The variable gain amplifier 24a amplifies or attenuates the amplitude of the input signal from the input terminal Pi to a predetermined amplitude, and then outputs the input signal whose amplitude is adjusted to the gain control circuit 24b and the distributor 20. Then, the gain control circuit 24b measures the amplitude of the signal from the amplifier 24a, and adjusts an amplification factor or an attenuation factor of the amplifier 24a to get a predetermined amplitude. In this case, the predetermined amplitude signifies such an amplitude that the circuits 21 to 23 subsequent to the distributor 20 can be operated normally and also the jitter of the trigger signal can be reduced the most.

In other words, in case the high frequency signal in excess of several tens of GHz is handled, in many cases the circuits 21 to 23 are manufactured by using the compound semiconductor such as gallium arsenide, indium phosphorus, or the like. This is because an amplitude range of the signal necessary for the normal operation of the circuits 21 to 23 is present and in particular the jitter generated in the circuits 21, 23 is readily influenced by the amplitude of the input signal. Since remaining operations are similar to those of the generator shown in FIG. 1, FIG. 3, FIG. 5, their explanation will be omitted herein.

In this manner, the amplitude controlling section 24 controls the amplitude of the input signal from the input terminal Pi and outputs a resultant signal to the distributor 20. Thus, the frequency divider circuit 21 and the synchronizing circuit 23 can be operated optimally and stably. Therefore, the jitter generated in the frequency divider circuit 21 and the synchronizing circuit 23 can be suppressed further. As a result, the trigger signal that is in synchronization with the input signal and contains few jitters can be generated.

Here, the present invention is not limited to this, and following configurations may be employed.

In the generators shown in FIG. 1, FIG. 3, FIG. 5, FIG. 6, a configuration is shown wherein the signal that is synchronized with the measure signal (e.g., the clock signal) is used as the input signal. On the other hand, the clock signal reproduced from the measure signal by CDR (clock and data recovery) may be used as the input signal. Alternately, a repetitive signal having a predetermined frequency may be used as the input signal.

In the generators shown in FIG. 1, FIG. 3, FIG. 5, FIG. 6, an example in which the present invention is applied to the trigger signal (strobe signal) of the sampler of the sampling oscilloscope is listed. In this case, the present invention is not limited to the sampling oscilloscope, and may be applied to the sampler in other waveform measuring devices (e.g., real-time digital oscilloscope, or the like), the time measuring equipment, the measuring equipment such as the counter, or the like. In this manner, since the waveform measuring device can execute the sampling of the measured signal based on the trigger signal that contains few jitters, the measured signal can be measured with high accuracy.

In the generators shown in FIG. 1, FIG. 3, FIG. 5, FIG. 6, a configuration is shown wherein the frequency detector circuit 22 executes the frequency detection by using the signal that is divided into the low frequency from the synchronizing circuit 21. In this case, the frequency detection may be executed by using the trigger signal output from the synchronizing circuit 23. In this manner, since the frequency detector circuit 22 executes the frequency detection by using the trigger signal that contains few jitters, a diving ratio of the frequency divider circuit 21 can be controlled with good accuracy.

In the generators shown in FIG. 1, FIG. 3, FIG. 5, FIG. 6, a configuration is shown wherein the frequency detector circuit 22 is provided. If the frequency of the input signal has already been known, the frequency detector circuit 22 is not needed.

In the generators shown in FIG. 1, FIG. 3, FIG. 5, FIG. 6, an example is explained wherein the frequency of the input signal is set to 50 GHz, and the frequency of the frequency divided signal is set to 10 MHz. However, the frequency of the input signal and the frequency-divided signal may be any value.

In the generators shown in FIG. 3, FIG. 5, FIG. 6, a configuration is shown wherein the delaying section 23b delays the frequency-divided signal from the frequency divider circuit 21. However, the delaying section may be provided between the distributor 20 and the clock input terminal of the DFF 23a and may delay the signal fed to the clock input terminal of the DFF 23a.

In the generators shown in FIG. 3, FIG. 5, FIG. 6, a configuration is shown wherein the variable delaying section 23b delays the frequency-divided signal by a predetermined time Δτ. However, the frequency detector circuit 22 may read a table stored previously in a memory (not shown) that already contains information on a relation between the frequency and a delay time, and then may decide the delay time by using the read table.

In the generators shown in FIG. 3, FIG. 5, FIG. 6, a configuration is shown wherein the variable delaying section 23b varies the predetermined time Δτ. A fixed delaying section having a fixed delay time may also be used.

In the generators shown in FIG. 5, FIG. 6, a configuration is shown wherein the waveform shaper 23c applies a waveform shaping to the frequency-divided signal of the frequency divider circuit 21 and outputs a resultant signal to the variable delaying section 23b. However, the variable delaying section 23b need not be provided and the frequency-divided signal that is subjected to the waveform shaping may be output to the DFF 23a.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A trigger signal generator for outputting a trigger signal having a lower frequency than that of an input signal, the trigger signal generator comprising:
a frequency divider circuit for dividing a frequency of the input signal; and
a synchronizing circuit including a synchronizer for synchronizing the frequency-divided signal with the input signal.

2. The trigger signal generator according to claim 1, further comprising:
a frequency detector circuit for detecting a frequency of the frequency-divided signal and controlling a dividing ratio of the frequency divider circuit.

3. The trigger signal generator according to claim 1, wherein the synchronizer is a Delay flip-flop including:
a data input terminal into which the frequency-divided signal is input; and
a clock input terminal into which the input signal is input.

4. The trigger signal generator according to claim 1, wherein the synchronizing circuit includes:
a delaying section for delaying the frequency-divided signal and outputting the delayed signal to the synchronizer.

5. The trigger signal generator according to claim 1, wherein the synchronizing circuit includes:
a waveform shaper for shaping a waveform of the frequency-divided signal and outputting the waveform-shaped signal to the synchronizer.

6. The trigger signal generator according to claim 1, further comprising:
an amplitude adjusting section for adjusting an amplitude of the input signal and outputting the amplitude-adjusted signal, the amplitude adjusting section being provided at a front stage of the frequency divider circuit and the synchronizing circuit.

7. The trigger signal generator according to claim 1, wherein the trigger signal causes a sampler of a waveform measuring device to start sampling.
